(19) United States
(12) Patent Application Publication
(10) Pub. No.: US 2010/0262557 A1
(43) Pub. Date: Oct. 14, 2010

(54) SYSTEMS, METHODS, AND APPARATUS FOR GUIDING USERS IN PROCESS-DRIVEN ENVIRONMENTS

(76) Inventors: Rodrigo C. Ferreira, Lisbon (PT); Rodrigo L. de Sousa Coutinho, Linda-A-Velha (PT); Lucio E. Ferrao, Lisbon (PT); Carlos M. Alves, Lisbon (PT); Paulo A. Rosado, Alges (PT)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/760,012

(22) Filed: Apr. 14, 2010

Related U.S. Application Data
(60) Provisional application No. 61/169,167, filed on Apr. 14, 2009.

(51) Int. Cl. G06Q 10/00

(52) U.S. Cl. 705/348

(57) ABSTRACT

An extension to existing enterprise applications guides users through activities related to a business process.

### CROSS-REFERENCE TO RELATED APPLICATION

This application claims priority to and the benefit of U.S. Provisional Patent Application No. 61/169,167, filed Apr. 14, 2009, which is hereby incorporated herein by reference in its entirety.

### FIELD OF THE INVENTION

The invention generally relates, in various embodiments, to computer-assisted execution of business processes. More particularly, embodiments of the invention relate to systems, methods, and apparatus that guide users of enterprise applications through activities related to business processes.

### BACKGROUND

Enterprise software applications typically aim to improve the productivity and efficiency of an enterprise by supporting business processes. Many business processes are distributed and collaborative, involving several human actors that perform activities over several distinct applications. To ensure seamless and efficient interaction of these various actors and applications, business processes often define rules, procedures, and protocols to be followed.

Enterprise applications may contain functionality to enforce a business process. As a result, changes in the business process due to, for example, changes in market needs or business strategy may entail the need for corresponding adjustments in the employed enterprise applications. However, implementing changes in previously working applications creates a risk of introducing malfunctions, and can delay the technical deployment of the changes to the business process, sometimes even resulting in service interruptions. In addition, users may require training to cope with the new business process, which further delays its business deployment. Consequently, changes in business processes often diminish the efficiency increase obtained through enterprise applications.

### SUMMARY

In various embodiments, the present invention facilitates the deployment of new and the modification of existing business processes without requiring user training or changes to existing enterprise applications. In particular, described herein are systems, methods, and apparatus for enforcing business processes and guiding human actors—the end-users of the enterprise applications—through the business processes with accurate, updated activity listings, directions, and instructions. In various embodiments, the systems, methods, and apparatus utilize a business module that defines one or more business processes in combination with an extension to existing applications that implements these business processes. The extension generally communicates with the individual applications. In certain embodiments, the extension controls user navigation through the application(s), user interface content, and/or data transfer between the application(s) and a data repository. For example, the extension may trigger opening or closing an application, or redirect a user from one application or application screen to another, based on business rules and data stored in the repository. Further, the extension may cause the display of task lists or instructions to the user of an application, either within the application screen or in a separate window.

In general, in a first aspect, embodiments of the invention provide a method for implementing a business process in a computing system that uses a plurality of enterprise applications. The method involves running an extension that directs the use of the plurality of enterprise applications on a computing device so as to enforce the business process. The extension is based upon a computer-readable model of the business process and is changeable independently of the plurality of enterprise applications. As a result, the business process can be changed without modification to any of the plurality of enterprise applications. In some embodiments, the method also includes creating the model of the business process, e.g., using a visual modeling environment. Further, the method may include running at least one of the enterprise applications to execute an activity of the business process, and/or storing data generated during the execution of the activity in a data repository.

Running the extension may include executing computer-readable instructions for identifying an activity of the business process for execution, notifying a user of the activity (e.g., by causing a visual alert to appear in or in front of an application screen presented to the user), directing the user to an enterprise application and/or application screen associated with the activity (e.g., by launching the enterprise application or by displaying an executable link to the enterprise application to the user), providing contextual data to the application screen, and guiding the user through execution of the activity (e.g., by displaying instructions associated with the activity to the user).

Furthermore, running the extension may involve monitoring changes to data generated during execution of the business process. The activity for execution may be identified based, at least in part, on the changes to the data.

In a second aspect, various embodiments of the invention are directed to a system for implementing a business process. The system comprises computer memory storing a computer-readable model of the business process. The model defines a plurality of activities that involve the use of a plurality of enterprise applications. Further, the system includes an extension, based upon the model, for directing the use of the plurality of enterprise applications so as to enforce the business process. The extension can be changed independently of the plurality of enterprise applications such that the business process is changeable without modification to any of the plurality of enterprise applications. The system may further include a visual modeling environment for creating the computer-readable model, one or more of the enterprise applications used to carry out the business process, and/or a data repository implemented in a computer-readable storage medium for storing data generated during execution of the business process.

The extension may include computer-readable instructions for guiding a user through the business process by (i) notifying the user of an activity assigned to him or her, (ii) directing the user to an enterprise application associated with the activity, and (iii) displaying instructions associated with the activity to the user. The instructions may also create a visual user interface that guides the user through the business process. The visual user interface may be displayed in conjunction with a user interface of at least one of the enterprise applications.

In a third aspect, the invention features, in various embodiments, an article of manufacture that stores computer-readable instructions for implementing a business process in a computing system that uses a plurality of enterprise applications. The instructions include an extension, based on a computer-readable model of the business process, which directs the use of the plurality of enterprise applications so as to enforce the business process. The extension is changeable independently of the plurality of enterprise applications, thereby facilitating changes to the business process without modification to any of the plurality of enterprise applications.

In a fourth aspect, various embodiments of the invention are directed to a method for implementing and/or modifying a business process in a computing system that uses a plurality of enterprise applications. The method involves running, on a computing device, an extension that directs the use of the plurality of enterprise applications so as to enforce the business process; implementing a change to the business process, without modification to any of the plurality of enterprise applications, by modifying the extension; and then running the modified extension so as to enforce the modified business process.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a block diagram schematically illustrating the architecture of a system for guiding a user through activities associated with a business process in accordance with one embodiment of the invention;

FIG. 2A is a block diagram of a computer network in which the system of FIG. 1 is implemented at the server side in accordance with one embodiment of the invention;

FIG. 2B is a block diagram of a computer network in which the system of FIG. 1 is distributed between server and client computers in accordance with one embodiment of the invention;

FIGS. 3A-3F are screen shots depicting a user interface at various steps of an exemplary business process in accordance with one embodiment of the invention; and

FIGS. 4A-4E are screen shots of a visual development environment interface for defining business processes in accordance with various embodiments of the invention.

### DETAILED DESCRIPTION

In general, embodiments of the present invention pertain to systems, methods, and apparatus for guiding users of enterprise applications through the steps associated with one or more particular business processes.

“Enterprise applications” (or, for short, “applications”), as the term is used herein, are software applications that facilitate carrying out certain tasks in an enterprise. Examples of enterprise applications include word processing and spreadsheet software, databases and their associated interfaces for data entry and retrieval, email and other communication programs, as well as enterprise-specific, customized applications. Enterprise applications may be web-based, i.e., hosted on a server and accessed by the users through the Internet or another network, or installed on the individual users' machines (such as on their desktops, laptops, or cell phones or other handheld devices).

A “business process,” as the term is used herein, is a collection of related tasks or activities (i.e., series of tasks) that accomplish a particular goal or produce a particular service or product (whether for profit or not). Examples of business process include the recruitment of new employees, the procurement of goods, responses to customer service requests, the collection of customer feedback, and the generation of invoices, to name just a few. Typically, the execution of a business process involves several (in some cases tens or hundreds of) human actors, and includes both tasks that are carried out manually (such as, e.g., interviewing a job candidate), and tasks that are performed in an enterprise application (such as, e.g., entering an evaluation of the candidate into a recruitment database). Some enterprise applications are specific to a particular business process, whereas others are shared between multiple business processes. For example, accounting or spreadsheet software may be used both for generating expense reports for the enterprise and for billing customers, and a calendar for scheduling meetings may be used by all departments of the enterprise. Business processes may be hierarchically structured into multiple levels of processes and sub-processes. Further, two or more generally distinct business processes may have discrete connections. For example, the process of buying supplies for the enterprise may affect the process of generating expense reports for the enterprise, the connection between the processes being the purchase costs.

Because the successful execution of business processes is often contingent upon the coordination of activities between multiple actors and the completion of individual tasks in a particular order and in a prescribed manner, it may be desirable to enforce business processes through computer-assisted guidance of the actors through their assigned activities. Such guidance may include displaying task lists and instructions to the actors, reminding them of outstanding activities, recording information about the progress of an activity (e.g., by “listening” to changes in data generated through the activity), monitoring user-generated information for compliance with required formats, notifying actors of newly available activities (e.g., once a prerequisite activity has been completed by another actor), etc. In some instances, user guidance may be implemented directly in an enterprise application used to execute a particular business process. However, where a business process relies on multiple applications, ensuring cross-compatibility and communication between the applications to enforce the business process may be difficult. Further, whenever a business process enforced through the applications is modified, the applications themselves will have to be adjusted accordingly. This adjustment process may be time-consuming and prone to errors. Therefore, it may be desirable to provide a central functional unit, separate from the applications, for implementing business processes.

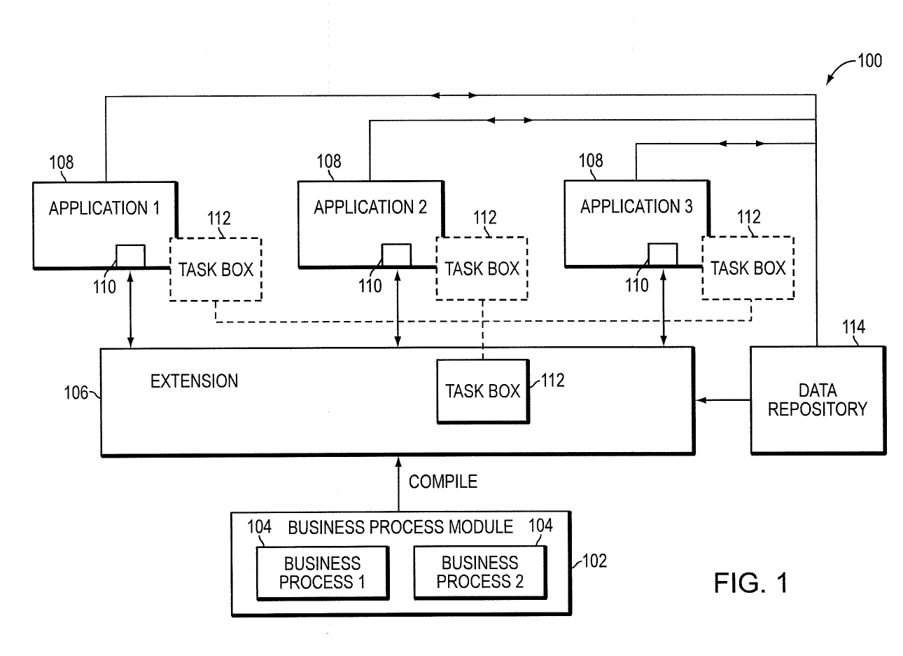

FIG. 1 schematically illustrates the architecture of an exemplary system 100 in which the applications for carrying out various steps of business processes are separate from the functional unit for enforcing the business processes. The system 100, as illustrated, includes a business process module 102 which defines one or more (in the example, two) business processes 104. Business process module 102 may be integrated with modeling software that allows a user to specify the order and logical interrelations of tasks or activities of a business process 104 by means of a visual process model, and associate enterprise applications, input and output data, due dates, and/or other properties with each task, as described in more detail below. The definition of the business processes 104 in the business module 102 may be saved in a structured model description format such as, for example, XML, and may then be converted to computer-executable instructions, which collectively form an extension 106. In addition to sections of computer-readable code for each business process, the extension may also contain code that is shared between the business processes, such as instructions that enable communication with other components of system 100.

The extension 106 interfaces with one or more (in the example, three) enterprise applications 108 through plug-ins 110, which can be pre-built into the applications 108. Further, the extension creates, when executed, a user interface 112, hereinafter referred to as a “task box” or alternatively as an “inbox”, that serves to guide each user of system 100 through the activities assigned to him or her in accordance with the business process (Alternatively, the task box may be implemented as a separate software application that communicates with and is controlled by the extension 106.) The task box 112 may have various displays (such as, e.g., a task list display or an instruction display), some of which may be universal to all applications 108, while others may be application-specific. In general, the content of the task box is tailored to each user, and is continuously or periodically updated based on the activities of all the other users assigned to the same business process. The task box 112 may be implemented in a pop-up window that appears besides or in front of an application screen and is automatically triggered by the extension 106, e.g., when a new task is assigned to the user. In some embodiments, the user has the option to invoke the task box 112 at any time manually, for example, via a button or other visual element that may be shown on the screen (e.g., next to or behind the application screen).

The task box 112 may notify the user of a particular activity to be completed, or provide the user with a list of activities assigned to him or her, or to a group of users to which he or she belongs. The task box 112 may also allow the user to filter or sort activities based, for example, on due date, type of activity, or another criterion. Further, the task box 112 may enable the user to claim any of the listed activities, for example, by clicking on it. This claiming action is then signaled to the extension 106, which locks the activity, and returns information about the activity, including instructions and an identifier for the enterprise application 108 associated with the activity. In general, the application associated with the selected activity is different from the application where the user started, i.e., where the task box 112 appeared or was invoked by the user. If that is the case, the extension 106 redirects the user to the application where the activity can be performed (e.g., by switching directly to that application and to the screen within the application where the activity is to be performed, or by displaying a hyperlink to the application in the task box 112). However, if the user selects an activity that can be completed within the same application in which the task box 112 originally appeared, the extension may simply redirect the user to the appropriate application screen. The application screen may contain contextual information based on the activity. For example, information that the user would otherwise have to fill in text fields in the application screen may already be pre-loaded. Further, within the application screen, the task box 112 then provides detailed instructions to the user on how to complete the activity. The activity may comprise several sub-activities, and the instructions may change as the user completes the sub-activities. The task box 112 may also cross-list other activities that may need to be completed prior to continuing work on the claimed activity.

As the user executes the instructions, application data associated with the application 108 generally changes. The extension 106 may monitor these changes to the application data in order to determine when the user has carried out all the instructions, and then close the activity automatically. Alternatively, the extension 106 may wait for a closing signal from the task box 112, sent when the user manually closes the activity. The extension 106 may then check the application data to validate the actions taken by the user based on business rules defined for the business process, and inform the user about his or her success or failure in completing all the steps to finish the activity. A successfully completed activity is removed from a “to-do” list maintained by the business extension 106. By contrast, when a user executes an option in the task box 112 to disclaim an uncompleted activity, the extension 106 unlocks the activity so that it can be subsequently claimed again by the same or another user.

Application data generated during the execution of an activity in an application 108, such as, for instance, information entered by the user via a keyboard or mouse, is typically stored in a central data repository 114. Conversely, the application may retrieve data necessary to carry out certain activities from the data repository 114. Data transfer between the application 108 and the repository 114 may be controlled by the extension 106, and may occur when an application is opened or a particular activity is claimed by the user, when the activity is completed or closed, or at certain times during execution of the activity. The data repository 114 may be compartmentalized (both virtually and/or by including multiple hardware storage components), and may organize data, depending on the needs of the enterprise, by business process, enterprise application, user, or any combination thereof, and/or by other criteria. Typically, although not necessarily, data are stored in a structured database, such as an Oracle, Berkeley, or SQL database. The extension 106 typically monitors changes in the data stored in the repository 114, and such changes may trigger events in the business process. For example, if data entries in database fields associated with a particular job applicant are completed, the extension 106 may notify a hiring manager of the new task of making a hiring decision based on the entries.

The system 100 facilitates the introduction of new business processes, or the modification of existing ones, in a manner that does generally not interfere in any way with the internal operation of the enterprise applications 108. If a business process 104 is changed in the business process module 102, e.g., by adding a new activity to the process that is to be carried out in one of the already existing applications 108, such change will be reflected in the corresponding computer code section in the extension 106, but will leave the application 108 itself unaffected. During execution of the modified business process, a user may then, at the appropriate time, be directed to the application where the newly added activity can be performed, and receive instructions on how to complete the activity. Similarly, if a new business process 104 is defined, and existing applications 108 are associated with the various tasks of the new process 104, such process may be seamlessly integrated with the applications 108 via a new portion of the extension 106. Users assigned to the new process are then automatically notified of their respective tasks by the task box 112 when the tasks become available (i.e., once preceding steps in the business process have been completed), and are guided through the tasks with appropriate instructions. Thus, changes to business processes do, typically, not present a need for additional user training, unless they require the use of new enterprise applications 108 with which users are not familiar. Furthermore, the instructions provided to the users by the task box 112 help the user to complete the new activities without the need for training.

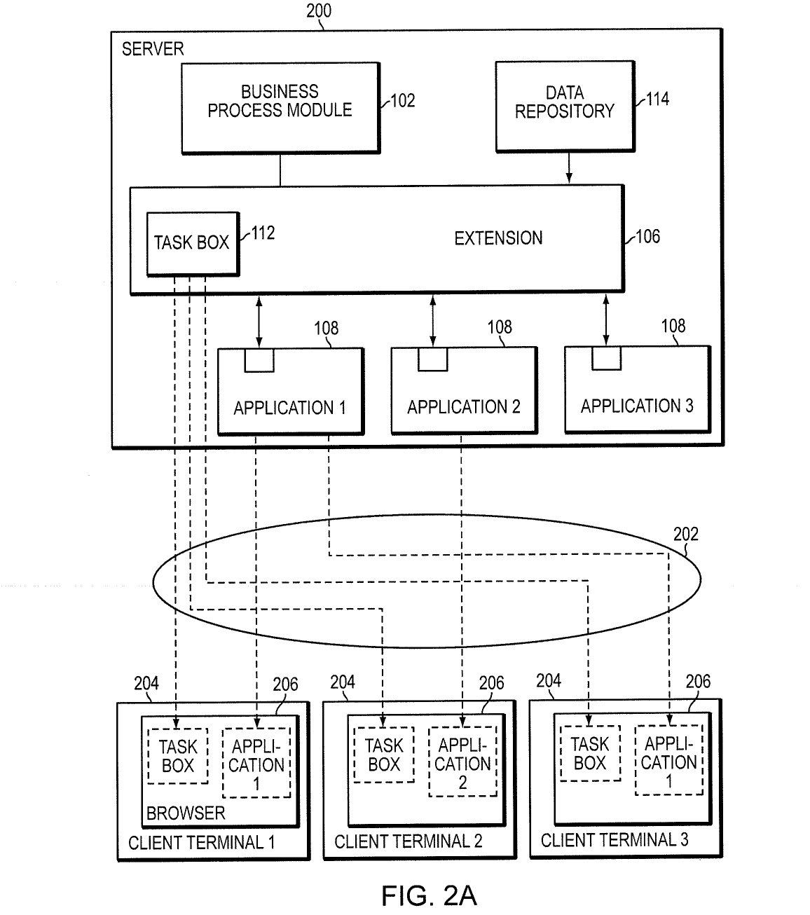

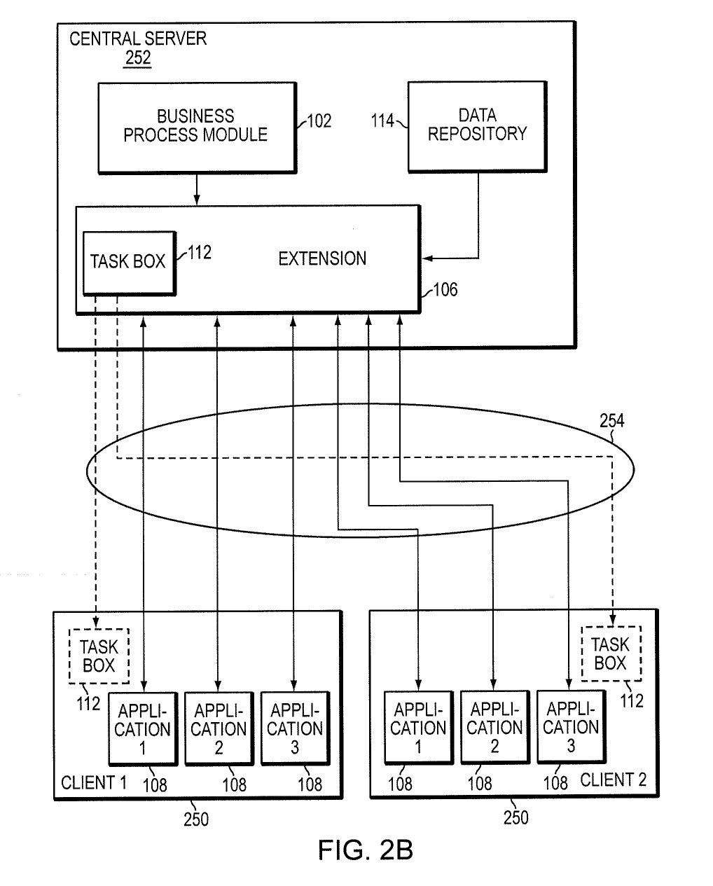

The system 100 may be implemented on a single computer or on a network of communicating computers, depending on the context. Further, the system 100 may be installed on a server system, or distributed over server and client machines. FIG. 2A illustrates an exemplary server-side implementation, in which the business process module 102, extension 106 (including the portions encoding the task box 112), and applications 108 are all stored on one or more storage media (e.g., hard drives or memory) of a host server 200 (which may comprise multiple intercommunicating computers), and are executed by one or more processors of the server 200. The various software components may be executed by the same or by distinct processors. For example, the extension 106 may be executed by one processor (or group of processors), and the enterprise applications 108 may be executed by another processor (or group of processors). The server 200 also includes data repository 114, which may be implemented, for example, on one or more hard drives.

In the embodiment shown in FIG. 2A, the enterprise applications 108 are web applications. A user may access the applications 108 remotely, over a network 202, at a client terminal 204 via a browser 206. For example, an instance of the user interface of an application 108 may be opened in a window of browser 206. The task box 112 may be displayed in a separate browser window or appear within the window of the application, as if it was an integral part of the application. The network 202 may be the Internet, a local area network, or an intranet of the enterprise. In general, multiple users may access the same or different applications 108 simultaneously over the network 202. For example, as illustrated in FIG. 2A, while one user accesses Application 1 at Client Terminal 1, another user may access Application 2 at Client Terminal 2. At the same time, a third user may access another instance of Application 1 at Client Terminal 3.

FIG. 2B illustrates an alternative embodiment of system 100, in which the various end-user applications 108 are desktop applications installed on different client computers 250. Each client computer 250 can access a central server 252 through a network 254 (such as the Internet or an intranet of the organization). The central server hosts the business process module 102, extension 106, and data repository 114, which, together, integrate the activities carried out at the various client computers 250. The task box 112 may be encoded in the extension 106 and accessed remotely by the users at client computers 250. Alternatively, it may be distributed and installed with the applications 108 on each client computer 250 as a separate program or as plug-ins of the applications, and communicate with the centrally located extension 106 via the network 254.

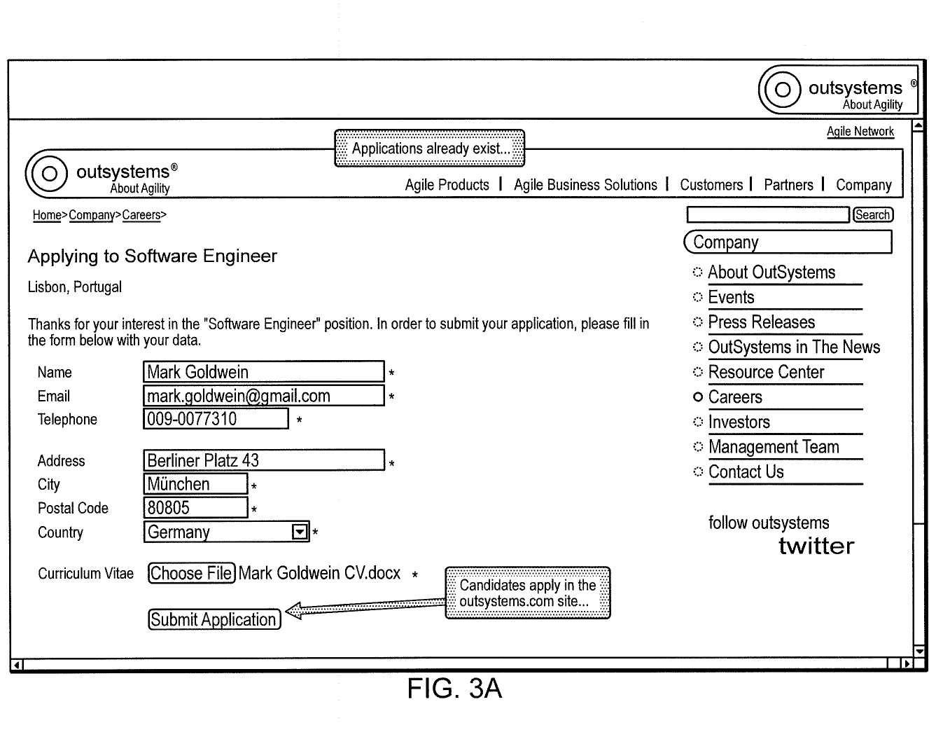

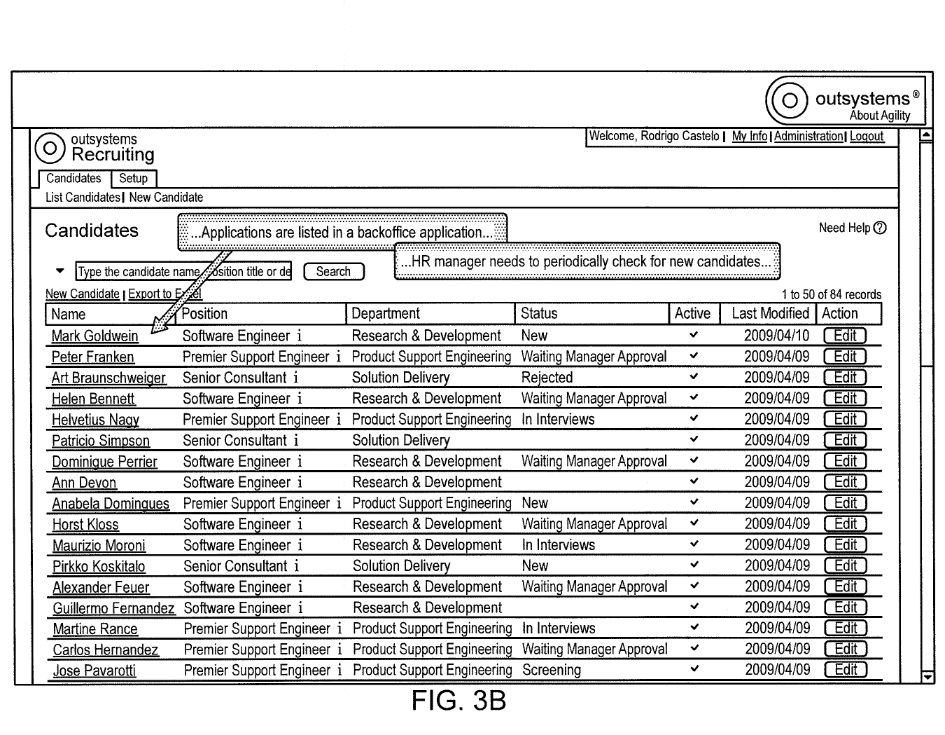

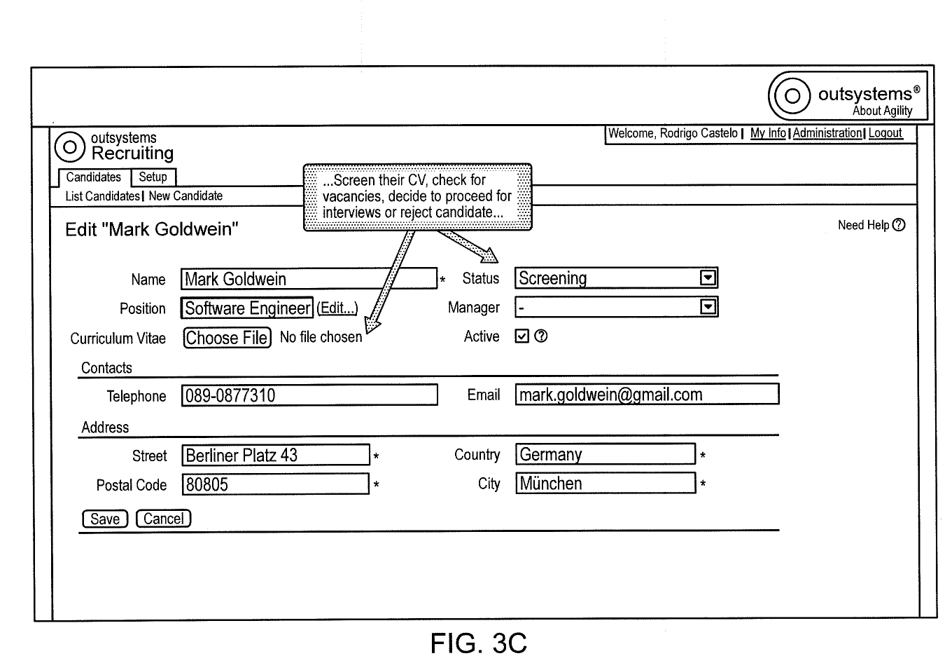

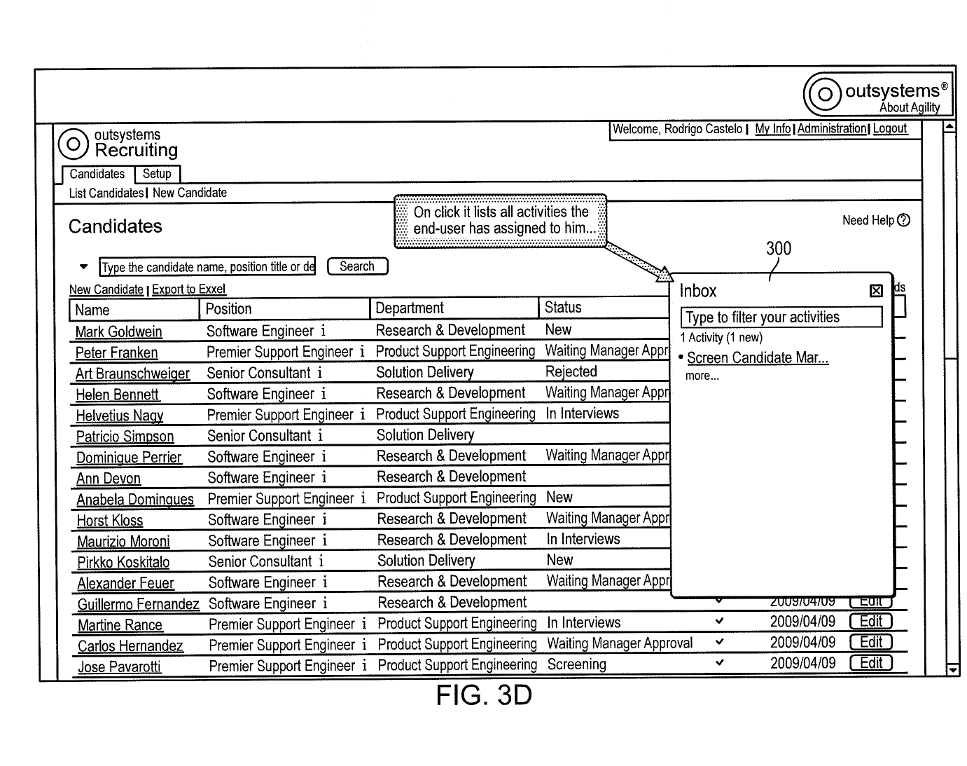

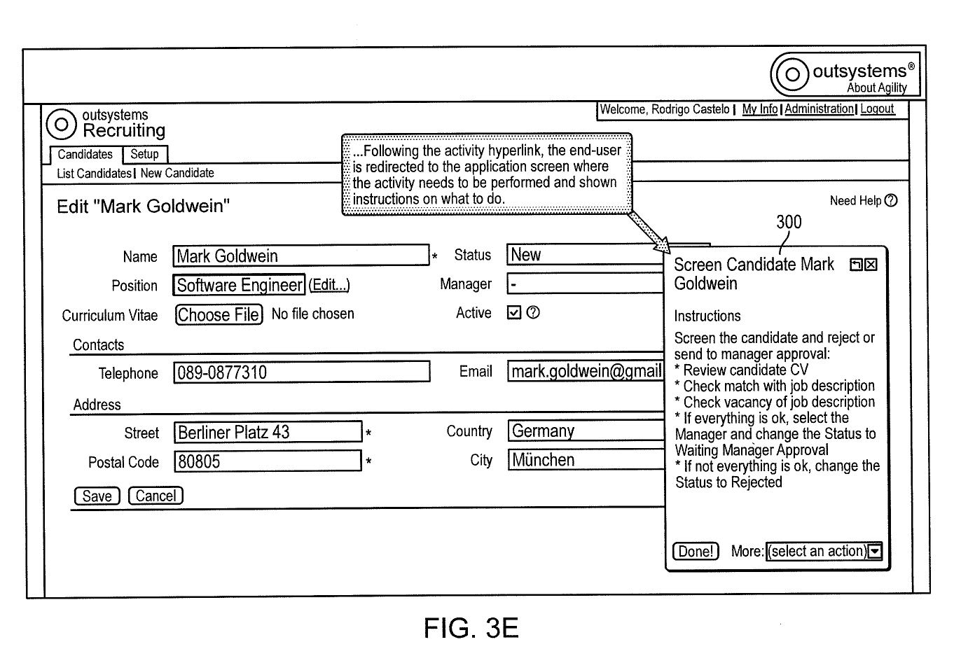

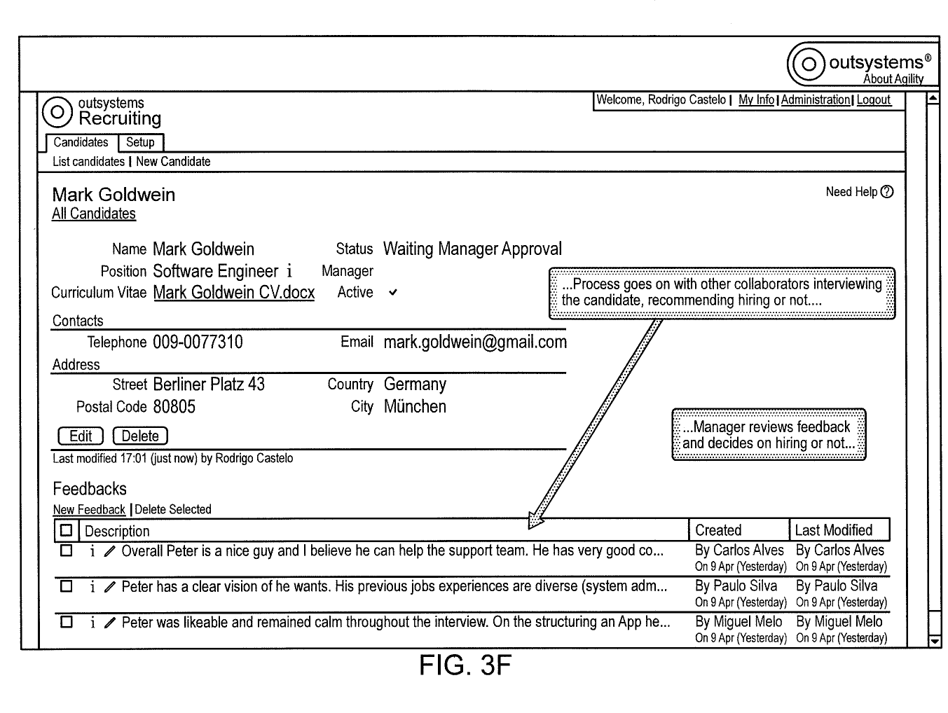

Embodiments of the invention may be utilized for many different kinds of business processes, including, but not limited to, recruiting new employees, procuring goods, selling products, and servicing customers. FIGS. 3A-3F illustrate an exemplary embodiment from the user's perspective in the context of a recruiting process. In a first step of the recruiting process, shown in FIG. 3A, a web application allows an Internet user that is interested in a job position to apply online by entering his contact information into a form and uploading his application documents. Upon submission of the application by the applicant via an action in the web application (such as, e.g., clicking on or hovering over a “submit” button), the applicant information may be stored in the data repository 114, and be forwarded to a second application, illustrated in FIG. 3B, which is accessible by the human resources (HR) department of the prospective employer. Typically, the HR department gathers information on multiple applicants. The HR application may provide a list of the applicants' names, along with the position applied for, the department offering the job, the status of the application, and any other relevant information. This information may be sorted and/or filtered by name, application date, position, etc. When the HR manager or another authorized person views the list of applicants, he or she may select an applicant and access an activity field associated with that applicant, e.g., by activating an “edit” button placed adjacent the listed application information. The activity field may then be displayed in another application screen of the HR application, as shown in FIG. 3C. There, the HR manager may list various tasks, such as checking the vacancy of the position, screening the application, interviewing the candidate, or sending the candidate an offer or rejection, in a drop-down menu (not shown), and select a task to be performed (in the illustrated example, screening).

Once a new task is associated with a particular candidate, that task automatically appears in the task box of the person or group of persons to which it is assigned. For example, FIG. 3D shows a task box 300 that appears in the context of an HR application screen. However, the task box 300 may appear in the context of any application, whether related to the recruitment process or not. As shown, the task box 300 informs the user that a new activity (“Screen Candidate . . . ”) was assigned to him or her. The task description may take the form of a hyperlink, which, when clicked on, directs the user to a new application screen, shown in FIG. 3E. In the new screen, contextual data including the name and contact information of the job candidate is already filled in. The content of the task box 300 is updated to display specific instructions for the selected activity, such as instructions to review the CV of the candidate and compare it against the job description, and to confirm that the position is still vacant. Based upon his or her review of the candidate's job application, the user updates the status indicator in the applicant activity field, and signals the completion of the activity, e.g., by clicking the “Done” button in the task box 300. In some embodiments, the task box 300 may automatically close when the updated activity field is saved. The completed screening activity may trigger new tasks, such as scheduling and conducting interviews with the job applicant, in various users' task boxes. In an interview feedback application (not shown), interviewers may report their impressions of an interviewed candidate. When all the interviews are completed and feedback from the interviewers has been entered, the status of the application is automatically changed to “Awaiting Manager Approval,” and the HR manager is so notified by a visual alert, e.g., a new entry in his or her task box. The feedback of several interviewers, along with the contact information of the applicant and the status of the application, may then be viewed by the HR manager in yet another screen of the HR application, shown in FIG. 3F.

While in the example described above, all activities relate to the same business process, i.e., recruiting, the business process module and extension may also be used to guide users through multiple business processes simultaneously. For example, the task box may list the activity “Submit Monthly Expense Report” from the process “Expense Reporting” together with the activity “Send Acceptance Letter” from the process “Recruiting.”

Additional features may be implemented in various embodiments. For example, a user, upon being alerted about a new activity, may have the opportunity to view explanatory information about the activity (such as the position of the activity within the business process, the due date, the event that triggered the activity, or other people associated with the activity) in the task box without having to claim the activity. Further, the user may be allowed to specify a time period for reminders of new, or opened but uncompleted, activities. In addition, the visual display (size, color, etc.) and other properties of the task box may be adjustable by the user.

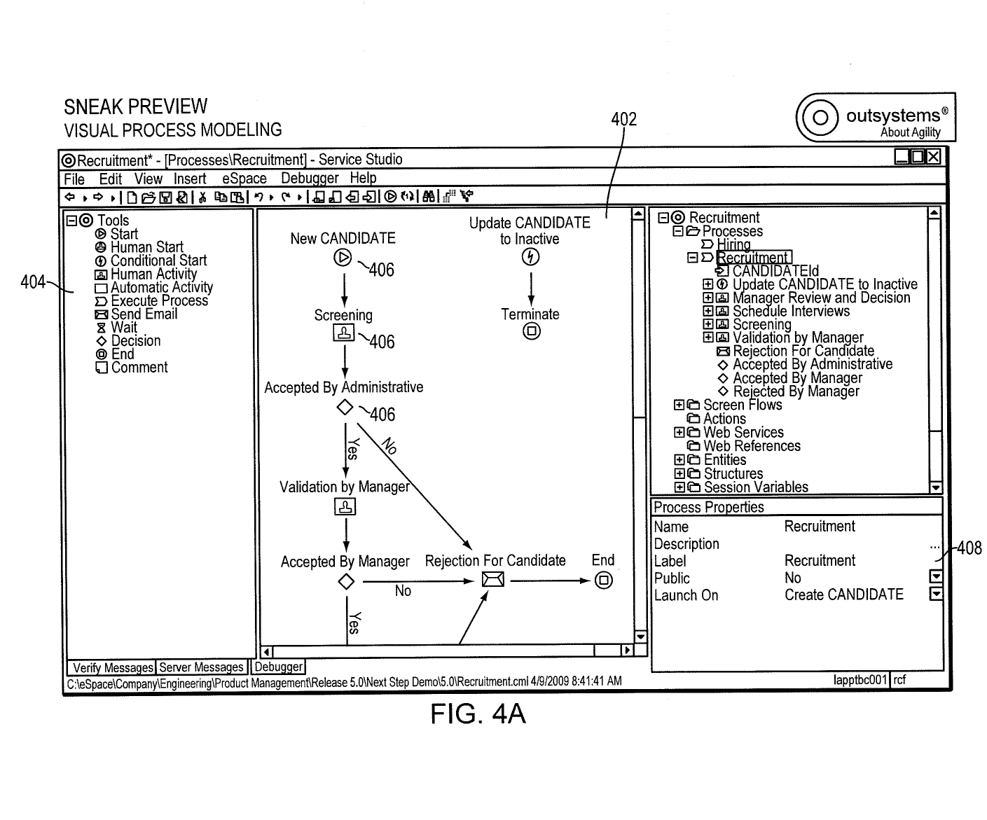

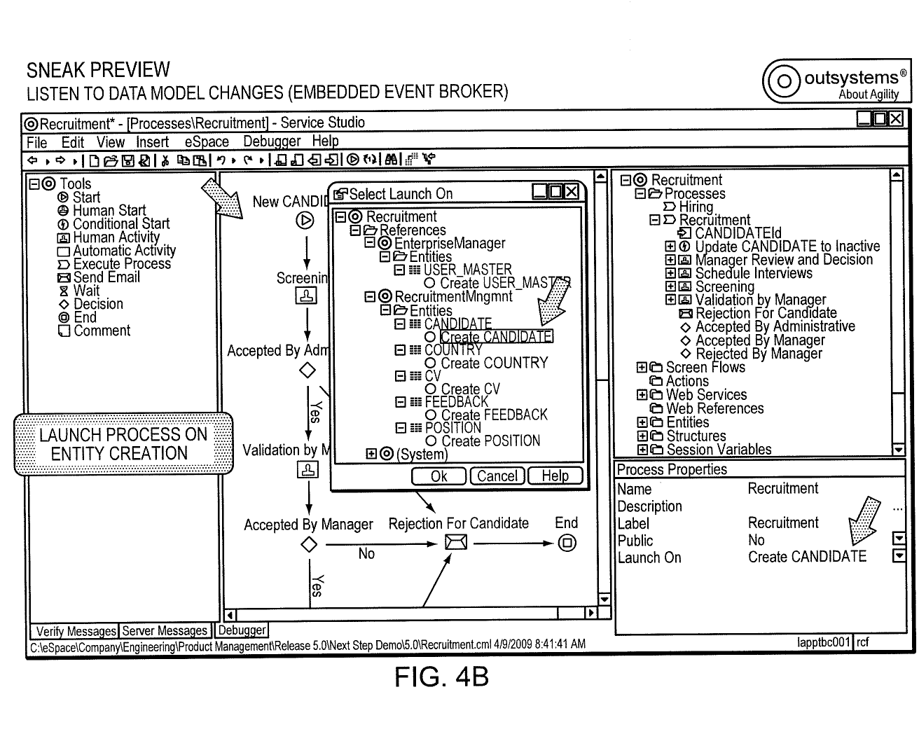

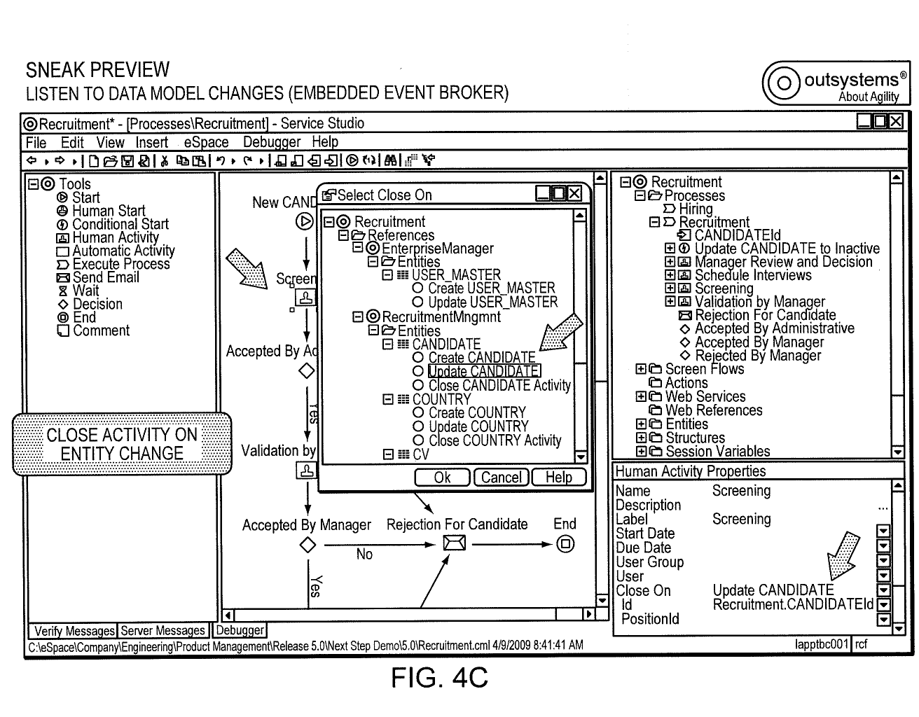

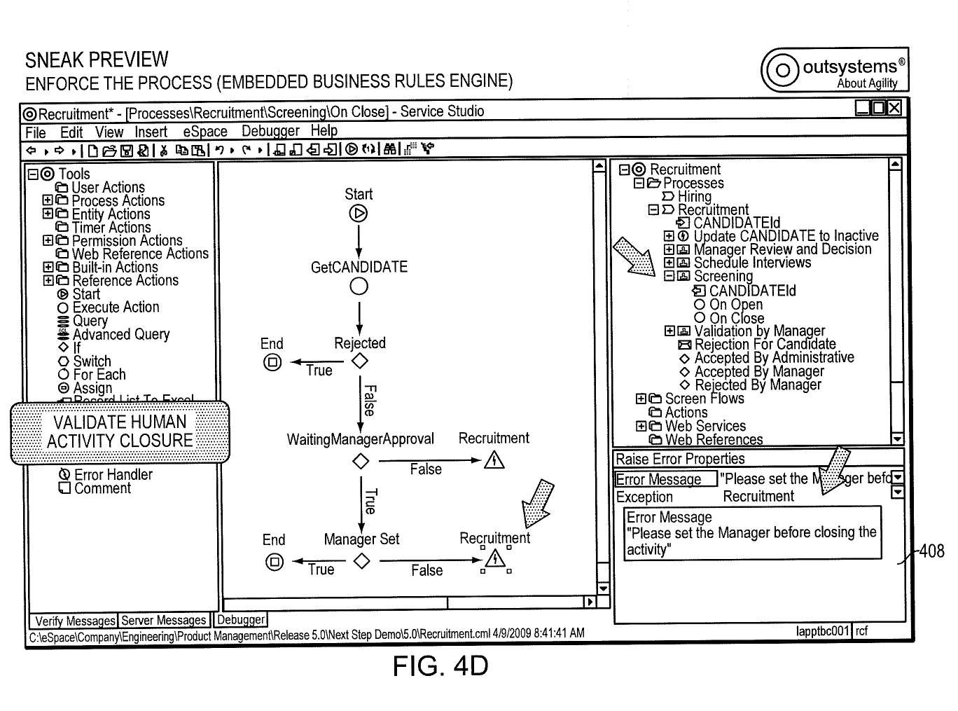

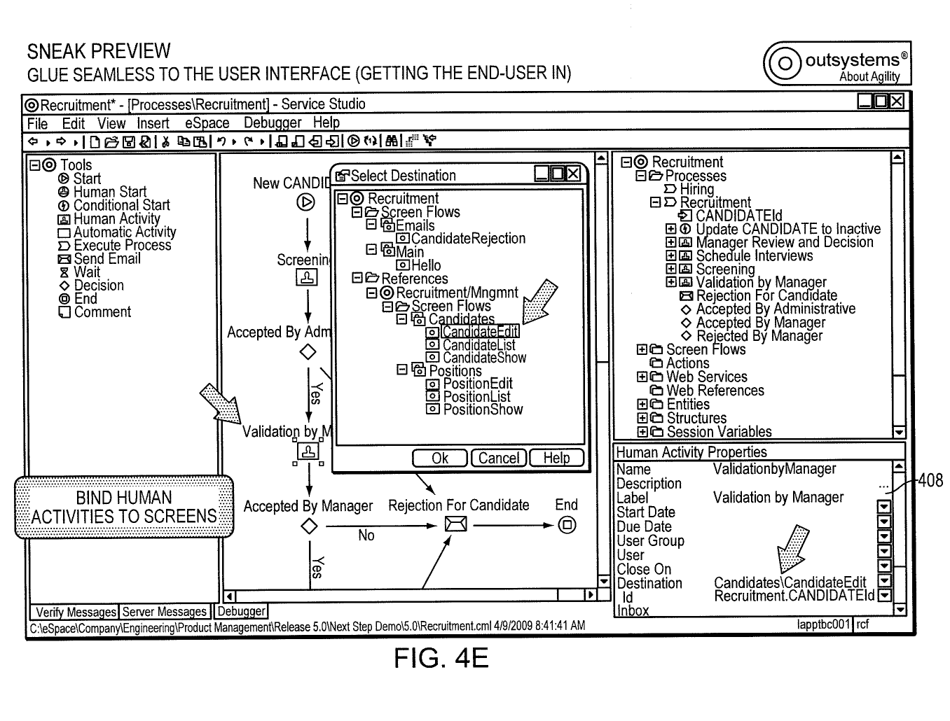

In various embodiments, the business process module 102 is integrated with a visual modeling environment that provides a developer with intuitive means for defining a business process. FIG. 4A shows a screen shot of such a modeling environment. The graphical user interface of the modeling environment includes a model canvas 402, and a tool palette 404 that contains icons for various steps and operations commonly used in business processes. The developer can drag and drop these icons into the model canvas 402 to generate the elements 406 of a model graph for the process, and then visually connect the elements to implement the underlying business logic. In the illustrated example, a visual model of a recruitment process is shown.

The modeling environment further includes a properties panel 408 that facilitates specifying functional properties of the process model. For example, FIGS. 4B and 4C illustrate the definition of trigger events for process launch and the closing of a process activity, respectively. Possible trigger events include, for example, a user action or a change in data stored in the data repository 114. FIG. 4D illustrates a business rule, also defined by a model graph, for the validation of an activity before closing. Various logical states in the business rule model are associated with error messages, as shown in the properties panel 408 of FIG. 4D. Further, the activities that make up the business process may be linked to various enterprise application screens in which the activities can be performed. FIG. 4E illustrates how an activity in the recruitment process is linked to a particular “destination” application and “destination” screen of that application in the properties panel 408. The process model provides an abstract description of the intended behavior of a computer system (such as system 100). Using the modeling environment, a developer can model distinct aspects of the system, such as the user navigation and user interface content to be presented to end users; the business rules that apply to the execution of interactive events triggered by the end users; and the data transmission and data repository formats and relationships that support the execution of the application.

Once a model of the business process is designed visually in the graphical user interface, it is compiled into a model description document that may be stored in the business process module 102. During compilation, the visual representation of the model in the modeling environment is translated into a structured representation amenable to further processing. In one embodiment, the model description document is structured using XML (eXtensible Markup Language). The XML code is then parsed to create executable code, which is inserted into the extension 106. In order to modify a business process, the developer may open the visual process model in the modeling environment, graphically implement any desired changes, and re-compile the model into a new model description document. In various embodiments, the extension 106 is then automatically updated based on the modified model description document. In general, the modeling environment and associated compiler may be used not only to define business processes, but also to create the application 108, as well as the task box that guides users through the business process. The compiler may contain functionality that provides each application automatically (i.e., without requiring any additional action on the part of the developer) with a plug-in 110 (see FIG. 1) that facilitates subsequent integration with the extension 106. Further detail about software generation using a visual modeling environment is provided in U.S. patent application Ser. No. 11/131,742, filed on May 18, 2005, which is hereby incorporated herein by reference in its entirety.

As will be understood by one of ordinary skill in the art, software components in accordance with the present invention need not be created using a visual programming environment. In general, they may be coded and implemented in any programming language, including, for example, C, C++, or JAVA. The software programs may be further translated into machine language or virtual machine instructions and stored in a program file in that form. The program file may then be stored on or in one or more computer-readable articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape.

Having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method for implementing a business process in a computing system that uses a plurality of enterprise applications, the method comprising:
running, on a computing device, an extension that directs the use of the plurality of enterprise applications so as to enforce the business process, the extension being i) based upon a computer-readable model of the business process and ii) changeable independently of the plurality of enterprise applications such that the business process is changeable without modification to any of the plurality of enterprise applications.

2. The method of claim 1, further comprising creating the model of the business process.

3. The method of claim 2, wherein creating the model comprises using a visual modeling environment.

4. The method of claim 1, further comprising running at least one of the enterprise applications to execute an activity of the business process.

5. The method of claim 4, further comprising storing data generated during the execution of the activity in a data repository.

6. The method of claim 1, wherein the running of the extension comprises executing computer-readable instructions for identifying an activity of the business process for execution, notifying a user of the activity, directing the user to an enterprise application associated with the activity, and guiding the user through execution of the activity.

7. The method of claim 6, wherein the running of the extension further comprises executing computer-readable instructions for directing the user to an application screen associated with the activity, and providing contextual data to the application screen.

8. The method of claim 6, wherein the running of the extension further comprises monitoring changes to data generated during execution of the business process.

9. The method of claim 8, wherein the activity for execution is identified based, at least in part, on the changes to the data.

10. The method of claim 6, wherein notifying the user of the activity comprises causing a visual alert to appear in or in front of an application screen presented to the user.

11. The method of claim 6, wherein directing the user to the enterprise application associated with the activity comprises at least one of launching the enterprise application or displaying an executable link to the enterprise application to the user.

12. The method of claim 6, wherein guiding the user through execution of the activity comprises displaying instructions associated with the activity to the user.

13. A system for implementing a business process, the system comprising:
computer memory storing a computer-readable model of the business process, the model defining a plurality of activities involving the use of a plurality of enterprise applications; and
an extension based upon the model for directing the use of the plurality of enterprise applications so as to enforce the business process, the extension being changeable independently of the plurality of enterprise applications such that the business process is changeable without modification to any of the plurality of enterprise applications.

14. The system of claim 13, further comprising a visual modeling environment for creating the computer-readable model.

15. The system of claim 13, further comprising the enterprise applications.

16. The system of claim 13, further comprising a data repository implemented in a computer-readable storage medium for storing data generated during execution of the business process.

17. The system of claim 13, wherein the extension comprises computer-readable instructions for guiding a user through the business process by (i) notifying the user of an activity assigned thereto, (ii) directing the user to an enterprise application associated with the activity, and (iii) displaying instructions associated with the activity to the user.

18. The system of claim 13, wherein the extension comprises computer-readable instructions for creating a visual user interface for guiding the user through the business process.

19. The system of claim 18, wherein the visual user interface is displayed in conjunction with a user interface of at least one of the enterprise applications.

20. An article of manufacture storing computer-readable instructions thereon for implementing a business process in a computing system that uses a plurality of enterprise applications, the instructions comprising:
an extension that directs the use of the plurality of enterprise applications so as to enforce the business process, the extension being i) based upon a computer-readable model of the business process and ii) changeable independently of the plurality of enterprise applications such that the business process is changeable without modification to any of the plurality of enterprise applications.

21. A method for implementing a business process in a computing system that uses a plurality of enterprise applications, the method comprising:
running, on a computing device, an extension that directs the use of the plurality of enterprise applications so as to enforce the business process;
implementing a change to the business process, without modification to any of the plurality of enterprise applications, by modifying the extension; and
running, on the computing device, the modified extension so as to enforce the modified business process.
